(19) United States
(12) Patent Application Publication
(10) Pub. No.: US 2003/0182184 A1
(43) Pub. Date: Sep. 25, 2003

(54) ADVERTISING BASED ON PRE-COMPUTED DISTRIBUTED PLAYLISTS

(76) Inventors: STEVEN L. STRASNICK, MOUNTAIN VIEW, CA (US); LANCE H. MORTENSEN, ALAMO, CA (US)

Correspondence Address: BANNER & WITCOFF, 1001 G STREET N W, SUITE 1100, WASHINGTON, DC, 20001, US

(21) Appl. No.: 09/435,240

(22) Filed: Nov. 5, 1999

Related U.S. Application Data
(63) Continuation-in-part of application No. 09/227,476, filed on Jan. 8, 1999.

(51) Int. Cl. G06F 17/60

(52) U.S. Cl. 705/14

(57) ABSTRACT

Methods and apparatuses to provide advertising based on pre-computed sub-playlists are described. The sub-playlists are generated based on one or more demographic characteristics. One or more sub-playlists are used to generate a playlist for a particular user or group of users. In one embodiment, the sub-playlists are generated at a network operations center or other location remote from the device on which the ultimate playlist is displayed; however, the sub-playlists can be generated locally or on a local network device. One or more sub-playlists corresponding to the demographic characteristics of a device user or group of users are combined to provide a playlist for the user or group of users. The playlist is displayed to the user or group of users.

The present U.S. Patent application is a continuation-in-part of U.S. patent application Ser. No. 09/227,476, filed Jan. 8, 1999, entitled “MICRO-TARGETED ADVERTISING.”

### FIELD OF THE INVENTION

The present invention relates to advertising using networked devices. More particularly, the present invention relates to dynamic targeted advertising to users of networked devices.

### BACKGROUND OF THE INVENTION

Typical advertisements take the form of broadcast advertisements. In other words individual advertisements (i.e., spots) are broadcast to multiple users/viewers/locations. The spots are typically linked to specific programming. For example, television advertisers purchase time during advertising breaks of specific programs, thereby targeting viewers attracted to the program during which one or more spots are purchased. Similarly, advertisers can purchase advertisement spots from Internet or online service providers (ISPs and OSPs) and/or World Wide Web pages, thereby targeting users of a particular ISP/OSP and users of a particular Web page, respectively.

In recent years, computer-based advertising has standardized the “Web Banner” format, which is static in nature in that an advertiser's spot is linked to, and embedded within, a specific Web page. However, viewers can easily “Scroll away” or ignore a banner spot. Another shortcoming of banner spots is that the duration of the impression is controlled by the viewer, who may click to another page before the banner is displayed.

Another shortcoming of the “Web Banner” format is that users can eliminate the presentation of graphical advertisements by “turning off” graphics in their browser settings. As a result, the advertiser is often charged for a “hit” or “impression” without any guarantee that the spot is viewed. Finally, a key problem facing Web advertising is the lack of a standardized, reliable metric of efficacy. Unlike TV or radio advertising that have established rating and demographic evaluation organizations (e.g. Nielson ratings), the Web has no such reliable measurement process.

One scheme that attempts to break the link between advertising and programming is disclosed in U.S. Pat. No. 5,794,210 entitled “ATTENTION BROKERAGE” (the '210 patent). The '210 patent discloses concepts referred to as “negatively priced information” and “orthogonal sponsorship.” Negatively priced information requires a participant to actively choose receive advertising. Orthogonal sponsorship breaks the link between advertising spots and programming by separating advertising spots from specific content for everyone receiving the content. In the advertising scheme disclosed in the '210 patent, a user chooses to be subjected to advertising in order to receive an award. Thus, the '210 patent describes a system that is driven by individual user's explicit participation on a spot-by-spot basis.

In general, the incentive to view an individual advertisement as the result of incentives provided in accordance with the '210 patent will often be insufficient to achieve significant success. The scheme of the '210 patent is best suited to the limited audience of active consumers of a specific product. However, this audience is not the primary target of traditional “brand imaging” mass market advertisers. Indeed, it is sponsored content (linked) associations and the repeated presentation of brand image messages that creates the “brand awareness” and “brand associations” that mass market advertisers seek. Because the scheme disclosed in the '210 patent requires active participation to begin involvement, the distribution of participation may be less than desired by marketing parties, or cost per impression may be too high, or both.

### SUMMARY OF THE INVENTION

A method and apparatus for generating a playlist is disclosed. The playlist can be used, for example, to play targeted advertisements or other digital content. Digital content is associated with one or more demographic characteristics to generate sub-playlists for the one or more demographic characteristics. One or more sub-playlists are combined to generated a user playlist based on a user's demographic characteristics. The digital content associated with the user playlist is displayed.

### BRIEF DESCRIPTION OF THE DRAWINGS

The present invention is illustrated by way of example, and not by way of limitations in the figures of the accompanying drawings in which like reference numerals refer to similar elements.

FIG. 1 illustrates one embodiment of a computer system.

FIG. 2 illustrates one embodiment of a network configuration.

FIG. 3 illustrates one embodiment of a network operations center coupled to a network.

FIG. 4 illustrates one embodiment of a layout of a graphical user interface.

FIG. 5 is one embodiment of a flow diagram for generating a sub-playlist.

FIG. 6 is a flow diagram for generation of a playlist from sub-playlists according to one embodiment of the invention.

FIG. 7 is a flow diagram of an advertisement script running within a client application according to one embodiment of the present invention.

### DETAILED DESCRIPTION

A method and apparatus for targeted advertising is described. In the following description, for purposes of explanation, numerous specific details are set forth in order to provide a thorough understanding of the present invention. It will be apparent, however, to one skilled in the art that the present invention can be practiced without these specific details. In other instances, structures and devices are shown in block diagram form in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Methods and apparatuses to provide advertising or other digital content based on pre-computed sub-playlists are described. The sub-playlists are generated associated with one or more demographic characteristics. One or more sub-playlists are used to generate a playlist for a particular user or group of users. In one embodiment, the sub-playlists are generated at a network operations center or other location remote from the device on which the ultimate playlist is displayed; however, the sub-playlists can be generated locally or on a local network device. One or more sub-playlists corresponding to the demographic characteristics of a device user or group of users are combined to provide a playlist for the user or group of users. The playlist is used to generate a script to play advertisements or other content to the user or group of users.

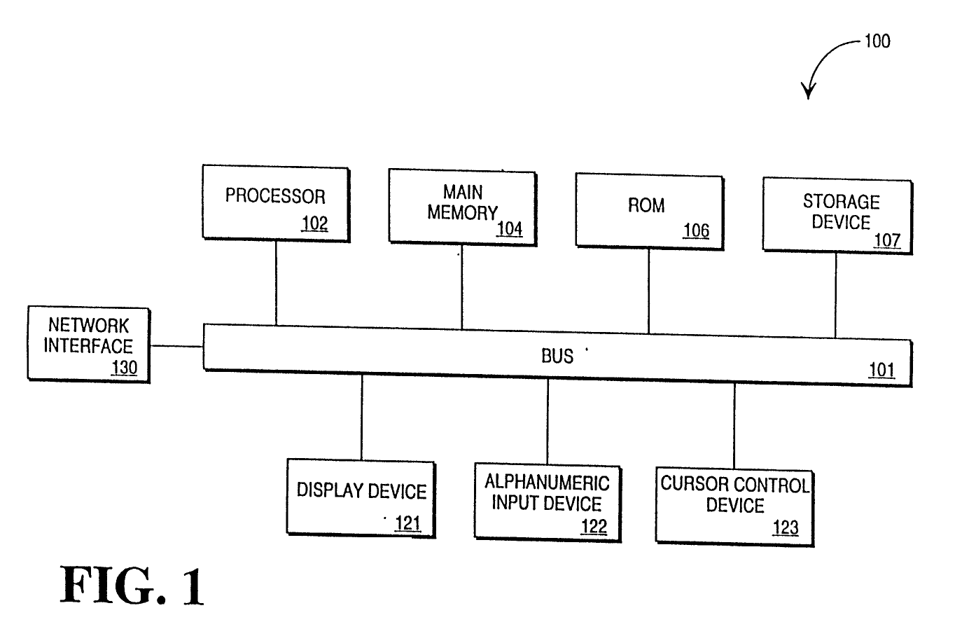

FIG. 1 illustrates one embodiment of a computer system. The computer system of FIG. 1 can be used in various capacities with the present invention. For example, the computer system can be a terminal used by a user to access local or remote resources, the computer system can be a server providing remote access to a resource, or the computer system can be a proxy server providing access to remote computer systems.

Computer system 100 includes bus 101 or other communication device for communicating information and processor 102 coupled to bus 101 for processing information. Computer system 100 further includes random access memory (RAM) or other dynamic storage device 104 (referred to as main memory), coupled to bus 101 for storing information and instructions to be executed by processor 102. Main memory 104 also can be used for storing temporary variables or other intermediate information during execution of instructions by processor 102. Computer system 100 also includes read only memory (ROM) and/or other static storage device 106 coupled to bus 101 for storing static information and instructions for processor 102. Data storage device 107 is coupled to bus 101 for storing information and instructions.

Data storage device 107 such as a magnetic disk or optical disc and corresponding drive can be coupled to computer system 100. Computer system 100 can also be coupled via bus 101 to display device 121, such as a cathode ray tube (CRT) or liquid crystal display (LCD), for displaying information to a computer user. Alphanumeric input device 122, including alphanumeric and other keys, is typically coupled to bus 101 for communicating information and command selections to processor 102. Another type of user input device is cursor control 123, such as a mouse, a trackball, or cursor direction keys for communicating direction information and command selections to processor 102 and for controlling cursor movement on display 121.

Computer system 100 further includes network interface 130 to provide access to a network, such as a local area network. One embodiment of the present invention is related to the use of computer system 100 to provide all or a portion of an incentive points management scheme. According to one embodiment, dynamic incentive points management is performed by one or more computer systems in response to processor(s) executing sequences of instructions contained in memory.

Instructions are provided to memory from a storage device, such as magnetic disk, a read-only memory (ROM) integrated circuit, CD-ROM, DVD, via a remote connection (e.g., over a network via network interface 130), etc. In alternative embodiments, hardwired circuitry can be used in place of or in combination with software instructions to implement the present invention. Thus, the present invention is not limited to any specific combination of hardware circuitry and software instructions.

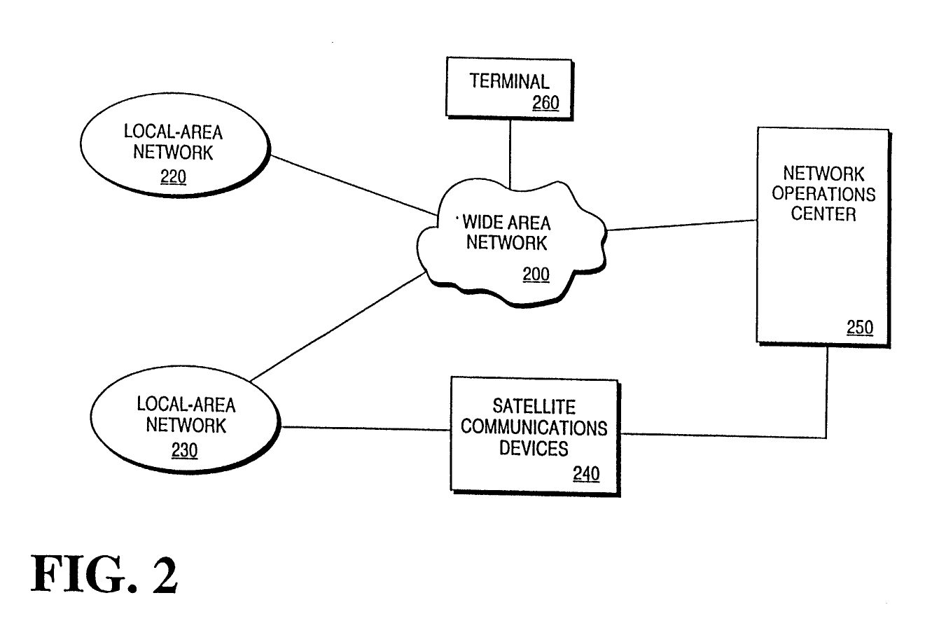

FIG. 2 illustrates one embodiment of a network configuration. The configuration of FIG. 2 is described in terms of both land based communications and satellite communications; however, the manner of communication is not central to the present invention. Therefore, the present invention is applicable to any interconnection of devices that provide access to local and remote resources.

Wide area network 200 provides an interconnection between multiple local area networks (e.g., 220 and 230), individual terminals (e.g., 260) and one or more network operations centers (e.g., 250). In one embodiment, wide area network 200 is the Internet; however, any wide area network (WAN) or other interconnection can be used to implement wide area network 200.

Terminal 260 is an individual terminal that provides access to network resources as well as local resources for a user thereof. In one embodiment, terminal 260 is a personal computer connected to wide area network 200 via a modem, a wireless connection, etc. Alternatively, terminal 260 can be a set-top box such as a WebTV™ terminal available from Sony Electronics, Inc. of Park Ridge, N.J., or a set-top box using a cable modem to access a network such as the Internet. Similarly, terminal 260 can be a “dumb” terminal or a thin client device such as the ThinSTAR™ available from Network Computing Devices, Inc. of Mountain View, Calif.

Local area network 220 provides an interconnection of devices at a local level. For example, local area network 220 can interconnect multiple computers, printers, and other devices within one or more buildings. Local area network 220 is coupled to wide area network 200. Similarly, local area network 230 provides an interconnection of devices. However, local area network 230 is coupled to satellite communications devices 240 as well as wide area network 200.

Network operations center 250 is coupled to wide area network 200 and provides access to network resources for terminal 260, local area network 220 and local area network 230. Communication between network communications center 250 and either terminal 260 or local area network 220 is accomplished by wide area network 200. As described in greater detail below, network operations center 250 and local area network 230 communicate via wide area network 200 and/or satellite communications devices 240.

In one embodiment network operations center 250 includes multiple servers (not shown in FIG. 2) that provide access to network and other resources. For example, network operations center 250 can include a Web proxy server that provides access to the World Wide Web (WWW, or the Web) for devices of local area network 220, local area network 230 and terminal 260. Network operations center 250 can also include other devices, such as a middleware server or a file server that provide information to devices coupled to network operations center 250.

In one embodiment, information is communicated between network operations center 250 and local area network 230 via uni-cast, multicast or broadcast satellite communications devices 240, which includes necessary components to provide communications between network operations center 250 and local area network 230. In one embodiment, satellite communication are accomplished using Transmission Control Protocol/Internet Protocol (TCP/IP) embedded within a digital video broadcast (DVB) stream; however, alternative communication protocols can be used. In one embodiment, satellite communications are bi-directional. Alternatively, if satellite communications are uni-directional, wide area network 200 can be used to provide a hybrid, asymmetric bidirectional communications system such as the SkySurfer™ platform available from Gilat Satellite Networks, Inc. of McLean, Va.

In one embodiment, sub-playlists are generated at network operations center 250. The sub-playlists are generated based on specific demographic profiled. For example, if an advertiser wishes to advertise to all males, a sub-playlist is generated that includes advertisements and/or other relevant information for each advertiser that wishes to advertise to males. Any demographic characteristic (e.g., females, particular age groups, residents of a particular ZIP code, people with particular interests). Multiple demographic characteristics can also be used to generate sub-playlists (e.g., 16-18 year old females, males who live in San Diego).

In one embodiment, the sub-playlists are generated in network operations center 250 and distributed to local are networks (e.g., 220 and 230) or terminals (e.g., 260). A device on the local area network or the terminal combines the sub-playlists based on a user's specific demographic profile to generate a playlist that is tailored to the user. By generating and distributing sub-playlists, the computational requirements to generate a playlist that is specific to a particular user.

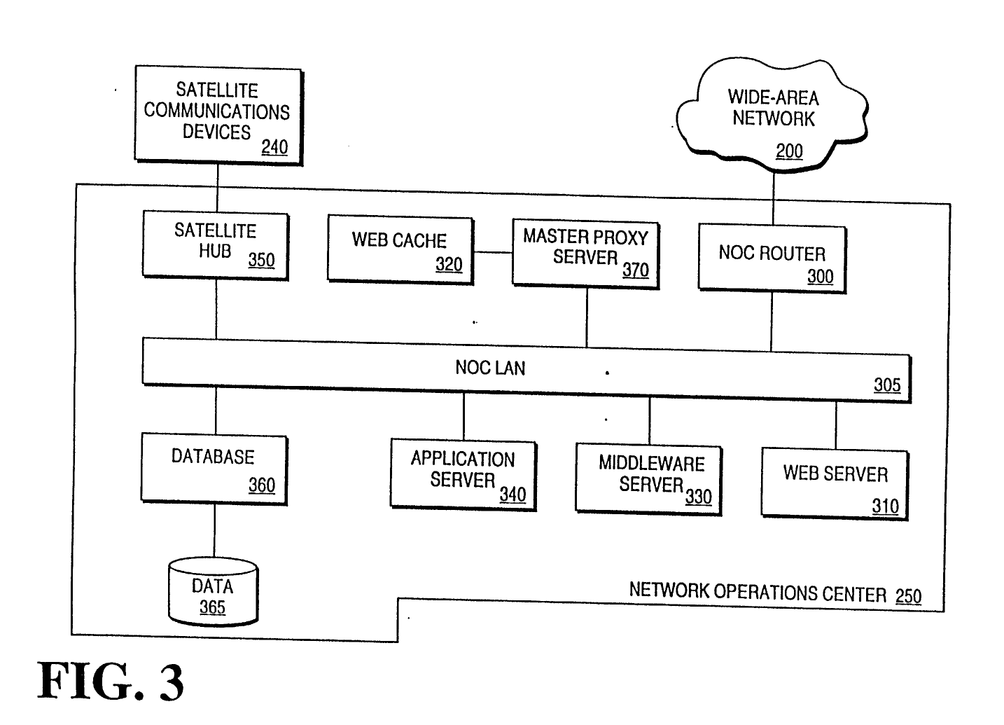

FIG. 3 illustrates one embodiment of a network operations center coupled to a network. With respect to description of FIG. 3, wide area network 200 and satellite communications devices 240 are implemented as described above in FIG. 2. Notwithstanding being described as including certain types of servers and other devices, network operations center 250 can include different or additional components as well as multiple components, for example, multiple Web servers. Each server can be one or more software and/or hardware components.

Network operations center (NOC) 250 provides resources to local area networks and individual terminals (not shown in FIG. 3) as well as a gateway to a larger network such as the Internet. Thus, network operations center 250 can be used to provide a controlled set of resources while being part of a larger network. This is particularly advantageous in situations where users of the local area networks are somewhat homogenous. For example, students in similar grade levels, professionals, and other groups.

Additional, uses and details of the network of FIG. 2 and the network operations center of FIG. 3 can be found in U.S. patent application Ser. No. 09/216,016, entitled “OPTIMIZING BANDWIDTH CONSUMPTION FOR DOCUMENT DISTRIBUTION OVER A MULTICAST ENABLED WIDE AREA NETWORK” and U.S. patent application Ser. No. 09/216,018, entitled “A METHOD AND APPARATUS FOR SUPPORTING A MULTICAST RESPONSE TO A UNICAST REQUEST FOR DATA,” both of which are assigned to the corporate assignee of the present invention.

NOC router 300 is coupled to NOC LAN 305 and provides routing and firewall functionality for the servers and other components of network operations center 250. NOC router 300 can be implemented in any manner known in the art. In one embodiment, database 360 is coupled to NOC LAN 305. Database 360 can be used, for example, to store information about authorized users of associated local area networks, or to store information about resources that are available on each terminal connected to the network.

Database 360 can also be used to store statistics about network usage, advertisement media assets to be downloaded to devices of the local area networks, etc. In one embodiment database 360 is used to store placement profiles associated with various advertisements as well as user profile information for authorized users of the network. Data store 365 represents data stored by database 360 and can be one or more physical devices and logical data tables. In one embodiment, data store 365 is used to maintain placement profiles and user profiles. In one embodiment, the placement profiles are the demographic characteristics of a desired target audience for an advertisement. Information from the placement profiles is used to generate advertisement sub-playlists.

Master proxy server 370 is also coupled to NOC LAN 305 to provide World Wide Web resources to devices of the connected local area network(s) or individual terminals. In one embodiment web server 310 is a Hypertext Markup Language (HTML) and/or Secure Sockets Layer (SSL) server. Of course, Web server 310 can be another type of server (e.g. FTP, Multicast “carousel” data broadcast server, reliable file multicast server, UNIX host, media server, etc.). Web cache 320 is used to store Web resources (e.g., Web pages) that are most often accessed, most recently accessed, etc. In one embodiment, Web cache 320 stores a predetermined set of Web resources that are provided to the local area networks. In a school network environment, the cached Web resources can be, for example, a preapproved set of Web pages. In one embodiment all or a portion of the contents of Web cache 320 are replicated on local networks.

Middleware server 330 manages database applications and interfaces with other servers in network operations center 250. For example, middleware server 330 can determine which users have access to Web server 310 and grant access accordingly. Middleware server 330 can also dynamically generate a Web page, graphic or chart based on database content. In addition, middleware server 330 can acquire and process/evaluate data from a plurality of database servers and logical databases. In one embodiment, middleware server 330 generates the sub-playlists from the placement profile information.

Middleware server 330 can also be replicated on local area networks, such as local area networks 220 and 230 of FIG. 2, while providing the targeted playlist scheme of the present invention. Middleware server 330 can be executed in any sufficient manner known to the art, for example, WebObjects® available from Apple Computer, Inc. of Cupertino, Calif., or a similar database middleware product. Alternatively, each client and server can act as its own middleware device by interfacing with the database servers on their own behalf though existing database interfacing technologies such as the Common Object Request Broker Architecture (CORBA) as defined by Object Management Group, Inc. of Framingham, Mass. or COM+ available from Microsoft Corporation of Richmond, Wash.

Application server 340 provides applications programs to devices coupled to network operations center 250. Application server 340 conceptually represents two different types of servers. Application server 340 can be part of a client-server architecture where the server provides data to a client (e.g., HTML server, e-mail server, bulletin board server). Application server 340 can also be a software distribution and management server for “stand alone” programs. Master proxy server 370 provides World Wide Web access to devices coupled to network operations center 250. Master proxy server 370 can be implemented in any manner known in the art.

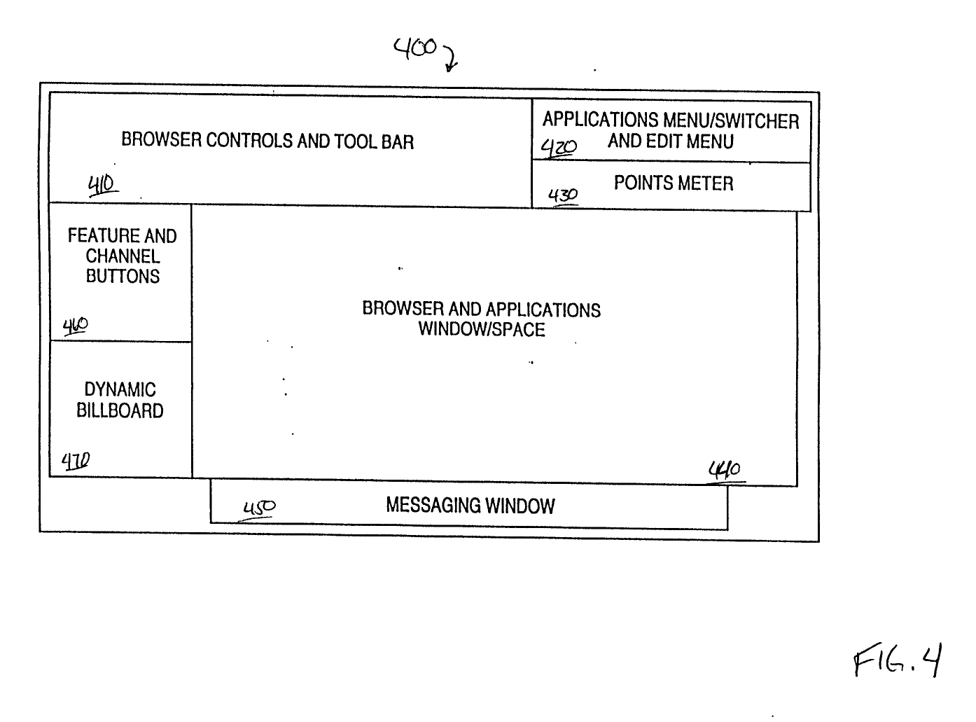

FIG. 4 illustrates one embodiment of a layout of a graphical user interface. In one embodiment user interface 400 provided to a user of a terminal is configured based on session access privileges granted to the user. In one embodiment user interface 400 provides the gateway by which a user accesses both local and remote resources.

In one embodiment browser controls and tool bar 410 provide graphical “buttons” that allow a user to perform certain operations. Browser controls and tool bar 410 can include, for example, “back,” “forward,” and “stop” buttons for browser control as well as “save,” “open,” and “print” buttons for general application control. Additional, fewer, and/or different buttons and commands can be included in browser control and tool bar 410.

In one embodiment applications menu/switcher and edit menu 420 provides application selection control and general editing control for multiple applications. For example, applications menu/switcher and edit menu 420 can include a list of all local and/or remote applications available to the user of the terminal on which user interface 400 is displayed. From the applications menu, the user can select an application to use. The edit portion provides general editing commands such as “cut,” “copy,” and “paste” for the user to move data between available applications.

In one embodiment points meter 430 provides a summary of incentive points or other points schemes available to the user. An incentive points management scheme is described in greater detail in U.S. patent application Ser. No. 09/213,238, entitled “INCENTIVE POINTS MANAGEMENT,” which is assigned to the corporate assignee of the present invention. Incentive points can be awarded to a user for clicking on, or otherwise interacting with, an advertisement.

Browser and application window 440 provides space for the user to interact with the resources accessed. For example, if a word processing application is being used, browser and application window 440 displays the word processing application window when the application is activated. Thus, the user can switch between applications and move data between applications that are available on the terminal using menu/switcher and edit menu 420 should the current user have sufficient privileges to do so on the current terminal. If a browser application is being used, browser and application window 440 is used as a browser window.

In one embodiment feature and channel buttons 460 provide access to features (e.g., e-mail, chat rooms, message boards, bookmarks) and channels (e.g., educational topics, news topics) available to the user. Feature and channel buttons 460 are configured based on the session privileges such that only the features and channels available to or associated with the user appear. Feature and channel buttons control what is displayed in browser and applications window 440.

In one embodiment, dynamic billboard 470 provides advertising according to the present invention and/or other information to the user while the user is using an application or browser. Of course, dynamic billboard advertising space 470 can be used for other purposes such as, for example, video conferencing, instant messaging, distance learning/instruction, news updates, or other uses.

The dynamic billboard (DBB) 470 displays advertisements according to the advertisement script generated from the playlist for the current user. In one embodiment, DBB 470 is an ITML window (e.g. its own browser) capable of displaying text, graphics, animations, videos, digital audio, embedded programs such as Java applets or ActiveX programs, forms, etc. The script controls what is presented in DBB 470 and when, and receives and processes input from the other windows of the application DBB 470 is integrated into (e.g. what Web page or application is currently in browser and applications window 440). Other ad containers can be used, for example, message window 450, or a background audio player, or an interstitial engine that runs in the Web browser window that presents advertisements from the local hard disk while pages are being loaded from the Web.

In alternative embodiments, advertisements are presented in a different manner. For example, advertisements can be presented as a banner, a message, an audio advertisement. Such an embodiment can be implemented by including an advertisement classification in the advertisement script and/or placement information the provides appropriate information describing the advertisement(s) to be presented.

In one embodiment, message window 450 can display messages to the user. For example, an instructor can send messages to students, a user of one terminal can send a message to a user of another terminal, a system administrator can send messages to a user or a group of users. Message window 450 can be used for messages that are independent of browser and applications window 440, so long as such messages are allowed by the current session privileges.

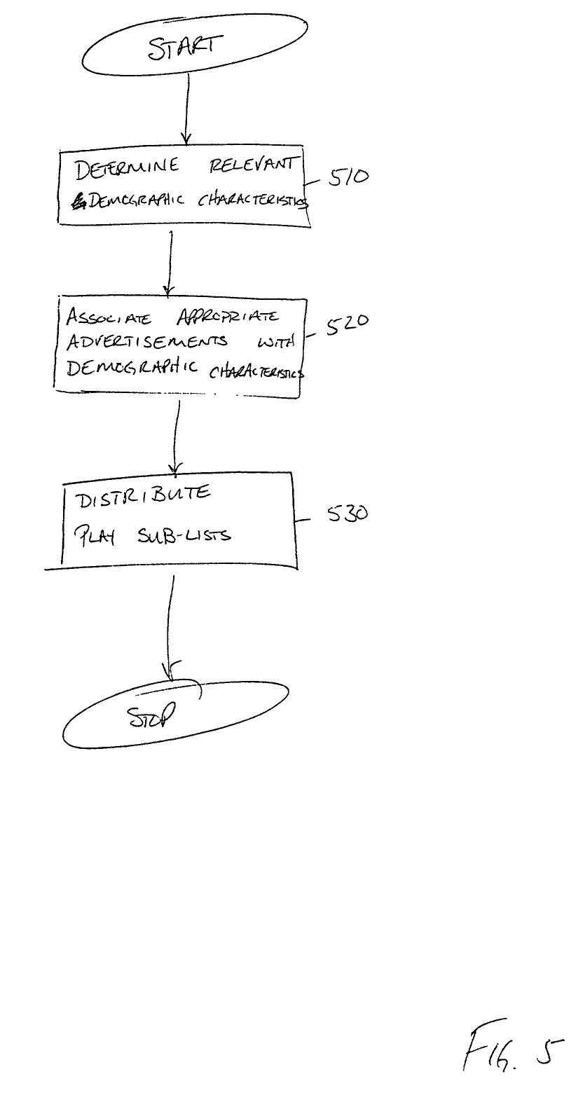

FIG. 5 is one embodiment of a flow diagram for generating a sub-playlist. The relevant demographic characteristics are determined at 510. In one embodiment, relevant demographic characteristics are those characteristics that some participating advertiser has indicated as a target demographic characteristic. In this manner, demographic characteristics can be added, deleted and/or modified without effecting other characteristics or requiring re-compilation of demographic characteristics.

Appropriate advertisements are associated with the one or more relevant demographic characteristics at 520. In one embodiment, the audio, video, graphics, or other data for the advertisements are stored in a file corresponding to the associated demographic characteristic (e.g., males.ad, 16-18.ad, SFO_females.ad, NYC_{—}18_males.ad). In an alternative embodiment, information describing the advertisements (e.g., pointers to advertisement data) can be stored in the files associated with the demographic characteristics rather than the advertisement data. Also, data other than advertisements can be distributed in a similar manner.

The sub-playlists are distributed at 530. In one embodiment, the sub-playlists are generated at a network operations center periodically (e.g., daily, weekly). The sub-playlists are then distributed to one or more terminals or local area networks. In one embodiment, the sub-playlists are distributed during off-peak hours (e.g., late night, early morning) so that network performance is not adversely affected; however, the sub-playlists can be distributed at any time. In one embodiment, the sub-playlists are broadcast via a satellite connection or other high speed connection; however, distribution can be accomplished in any appropriate manner.

Alternatively, the sub-playlists can also be generated by a device coupled to a local area network including the devices on which the advertisements are to be displayed. However, local generation of the sub-playlists increases the overall processing required because multiple devices generate redundant sub-playlists. In another alternative embodiment, sub-playlists are generated both locally and at a network operations center. For example, national or regional demographic characteristics (e.g., females, males, 21-35 year olds) can be used to generate sub-playlists at a network operations center covering the corresponding demographic characteristics. More specific local sub-playlists can be generated locally based on more local demographic characteristics (e.g., residents of a particular city, members of a particular organization). The sub-playlists from the network operations center and the local sub-playlists can be combined to provide targeted advertising.

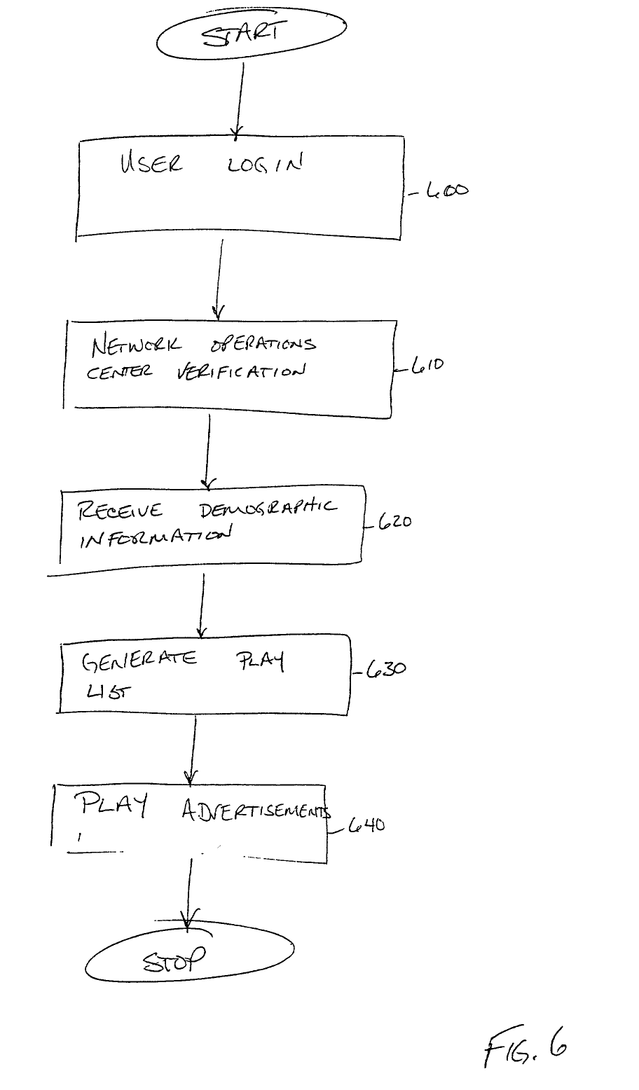

FIG. 6 is a flow diagram for generation of a playlist from sub-playlists according to one embodiment of the invention. A user logs in to a terminal at 600. In one embodiment, a user provides information (e.g., a user name and password, an encoded card) that identifies the user.

In one embodiment, user login information is verified at a network operations center at 610. In alternative embodiments, user login verification is performed by a device on a local area network or by the device where the user logs in. As part of the user verification, stored demographic information related to the user is retrieved. In one embodiment, user demographic information is obtained as part of a registration process; however, demographic information can also be derived from observing the user (e.g., Web sites visited, purchases made).

The demographic information retrieved as part of the user verification process is received at 620. In one embodiment, the demographic information is received by a database or other device coupled to the same local area network as the device on which the user logged in. Alternatively, the device that user is using can receive the demographic information. In one embodiment, the device that receives the demographic information has previously received one or more sub-playlists. Alternatively, the device that receives the sub-playlists is different than, but coupled to, the device that receives the demographic information.

A playlist that is specific to the user's demographic profile is generated at 630. In one embodiment, a database that receives the sub-playlists and the user's demographic information combines the sub-playlists that correspond to the user's demographic information to generate a playlist. The advertisements are played at 640. In one embodiment, the advertisements are played on dynamic billboard 470 in response to a script based on the playlist; however, the advertisements can be played in another manner.

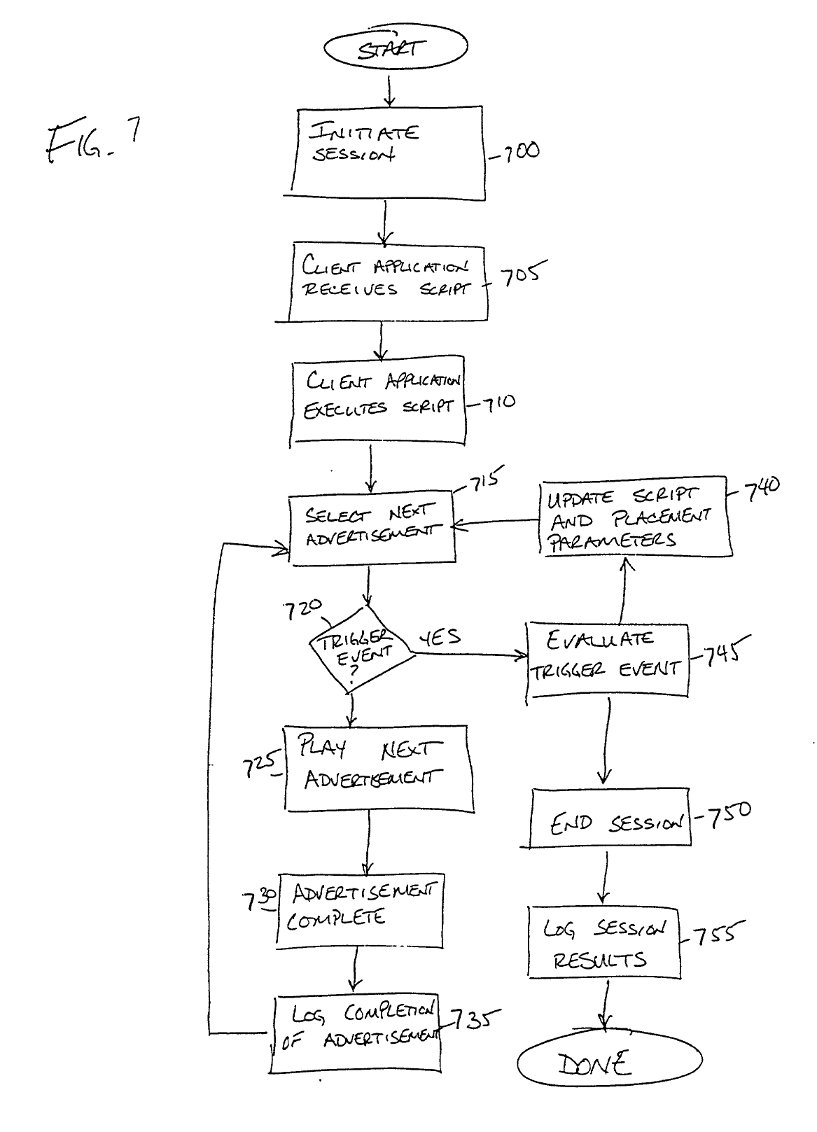

FIG. 7 is a flow diagram of an advertisement script running within a client application according to one embodiment of the present invention. A client session is initiated at 700. A client session can be initiated, for example, by a user logging on at a terminal that the user is authorized to use. As a result of the session initiation, an advertisement script is dynamically generated as described above.

The client application receives an advertisement script for the session at 705. In one embodiment, the advertisement script is received from a middleware or advertisement server in a network operations center. Alternatively, the script can be received from a local server or other device.

The client application executes the script at 710 by displaying advertisements according to the placement, order, duration, and other information in the advertisement script. The client application obtains advertisement assets from one or more sources (e.g., remote server, local server, internal hard drive) indicated by the script.

During execution of the advertisement script, the client application determines a next advertisement to display at 715. In one embodiment, the advertisement selected is determined based on input and output trigger/modification events. For example, if a user selects a remote resource (e.g., Web page) associated with an advertisement in the script, the script ordering may be modified.

The client application or the middleware server determines whether any events have occurred that are trigger events at 720. If so, the trigger event is evaluated and the appropriate action is taken at 745. For example, an advertisement can be inserted in, or deleted from, the rotation script, the script can be paused, or timing can otherwise be modified. In one embodiment, the script pauses at 740 while script information and/or placement parameters are updated based on the modification/trigger event. Execution of the script continues at 715.

If evaluation of the trigger at 745 indicates that the session is ending, the session ends at 750. In one embodiment, after the session ends, the advertisement log is archived at 755. The advertisement log reports what advertisements were displayed during the session and other related information (e.g., the user's ID, the terminal's ID, if the user clicked on an advertisement, what trigger events occurred during the session). In one embodiment, the report is stored in a database in the network operations center. The report can be used to dynamically generate and aggregate effected advertising statistics, for example, to report demographic information, for billing purposes, etc.

Because the architecture of the present invention provides more detailed information about users to which advertisements are displayed, the present invention can also provide detailed reports based on the advertisement log. For example, the advertisement log can indicate users, times, advertisement categories and other information related to advertisements that were successful (e.g., a user clicked on the advertisement, a user visited a particular Web page) or unsuccessful (e.g., a user changed his/her interest profile to avoid the advertisement). The more detailed reporting can be used to provide more economical and relevant pricing structures than would other wise be available. For example, each placement parameter can have an associated price and/or billing rate.

If a trigger event does not occur at 720, the next advertisement in the rotation portion of the script is displayed at 725. The advertisement is displayed until the appropriate duration has expired at 730. In one embodiment, the hit/impression information is recorded at 735 at the end of the advertisement duration. A subsequent advertisement is then displayed at 715.

In the foregoing specification, the present invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method of generating a playlist, the method comprising:
associating digital content with one or more demographic characteristics to generate sub-playlists for the one or more demographic characteristics;
combining one or more sub-playlists to generated a user playlist based on a user's demographic characteristics; and
displaying the digital content associated with the user playlist.

2. The method of claim 1 wherein the digital content comprises one or more advertisements.

3. The method of claim 1 wherein the digital content comprises audio/visual content.

4. The method of claim 1 further comprising distributing the sub-playlists to one or more distributed local area networks.

5. The method of claim 4 wherein distribution occurs during off peak hours.

6. The method of claim 1 wherein combining one or more sub-playlists to generated a user playlist based on a user's demographic characteristics further comprises:
distributing the one or more sub-playlists from a network operations center to one or more distributed local area networks;
determining a user's demographic characteristics at a local area network where the user logs in;
combining the one or more sub-playlists at the local area network where the user logs in.

7. The method of claim 1 further comprising generating a script in response to the playlist, the script to control playback of digital content associated with the playlist.

8. An apparatus for generating digital content playlists, the apparatus comprising:
means for associating digital content with one or more demographic characteristics to generate sub-playlists for the one or more demographic characteristics;
means for combining one or more sub-playlists to generated a user playlist based on a user's demographic characteristics; and
means for displaying the digital content associated with the user playlist.

9. The apparatus of claim 8 wherein the digital content comprises one or more advertisements.

10. The apparatus of claim 8 wherein the digital content comprises audio/visual content.

11. The apparatus of claim 8 further comprising means for distributing the sub-playlists to one or more distributed local area networks.

12. The apparatus of claim 11 wherein distribution occurs during off peak hours.

13. The apparatus of claim 8 wherein combining one or more sub-playlists to generated a user playlist based on a user's demographic characteristics further comprises:
means for distributing the one or more sub-playlists from a network operations center to one or more distributed local area networks;
means for determining the user's demographic characteristics at a local area network where the user logs in;
means for combining the one or more sub-playlists at the local area network where the user logs in.

14. A network comprising:
an asset database, the asset database to store play sub-lists corresponding to one or more demographic characteristics; and
a terminal to grant user access to the network, the terminal to communicate identification information indicating demographic characteristics of the user to the asset database and to receive a playlist from the asset database based on demographic characteristics of the user, wherein the playlist is generated from the one or more play sub-lists.

15. The network of claim 14 further comprising a network operations center having an advertisement database, the advertisement database to generate the play sub-lists.

16. The network of claim 15 wherein the advertisement database distributes the play sub-lists to the asset database.

17. The network of claim 15 wherein the advertisement database determines the user's demographic information based on the identification information and communicates the user's demographic information to the asset database.

18. The network of claim 14 wherein the asset database and the terminal are coupled to a common local area network.

19. A machine-readable medium having stored thereon sequences of instructions to, when executed, cause one or more electronic devices to:
associate digital content with one or more demographic characteristics to generate sub-playlists for the one or more demographic characteristics;
combine one or more sub-playlists to generated a user playlist based on a user's demographic characteristics; and display the digital content associated with the user playlist.

20. The machine-readable medium of claim 19 wherein the digital content comprises one or more advertisements.

21. The machine-readable medium of claim 19 wherein the digital content comprises audio/visual content.

22. The machine-readable medium of claim 19 further comprising sequences of instructions to, when executed, cause the one or more electronic devices to distribute the sub-playlists to one or more distributed local area networks.

23. The machine-readable medium of claim 22 wherein distribution occurs during off peak hours.

24. The machine-readable of claim 19 wherein the sequences of instructions to cause the one or more electronic devices to combine one or more sub-playlists to generate a user playlist based on a user's demographic characteristics further comprise sequences of instructions to cause the one or more electronic devices to:
distribute the one or more sub-playlists from a network operations center to one or more distributed local area networks;
determine a user's demographic characteristics at a local area network where the user logs in;
combine the one or more sub-playlists at the local area network where the user logs in.

25. The machine-readable medium of claim 19 further comprising sequences of instructions to, when executed, cause the one or more electronic devices to generate a script in response to the playlist, the script to control playback of digital content associated with the playlist.
